(19) United States
(12) Patent Application Publication
(10) Pub. No.: US 2013/0033355 A1
(43) Pub. Date: Feb. 7, 2013

(54) THERMAL OVERLOAD PROTECTION ARRANGEMENT

(71) Applicants: Thomas Meyer, Ottenstein (DE); Steffen Pfortner, Springe (DE)

(72) Inventors: Thomas Meyer, Ottenstein (DE); Steffen Pfortner, Springe (DE)

(73) Assignee: PHOENIX CONTACT GMBH & CO. KG, Blomberg (DE)

(21) Appl. No.: 13/642,383

(22) PCT Filed: Aug. 5, 2011
(86) PCT No.: PCT/EP2011/063548

§ 371 Date: Oct. 19, 2012

(30) Foreign Application Priority Data
Aug. 6, 2010 (DE) 10 2010 036 907.1
Oct. 8, 2010 (DE) 10 2010 038 066.0

(51) Int. Cl. H01H 71/20

(52) U.S. Cl. 337/147

(57) ABSTRACT

A thermal overload protection arrangement for protection of an electrical component, which is arranged on a mount device having current-carrying elements, has a plurality of soldered connections, which make electrical contact between in each case on of the current-carrying elements and an associated connection of an electrical part and melt if the component is overloaded, and a disconnection apparatus for disconnection of at least one of these connections. The part is or at least has the component, and the disconnection apparatus is a disconnection apparatus which prestresses the component with respect to the mount device at least when it is heated for the physical separation of the component from at least one of the current-carrying elements, which trips when the soldered connections melt. The invention also relates to a corresponding method for protection of a component.

The invention relates to a thermal overload protection arrangement for protecting an electrical component arranged on a mounting device having current-carrying elements, in particular electronic components such that the overload protection arrangement has a plurality of electrically contacting soldered joints which contact one of the current-carrying elements with a respective terminal of an electrical part and which melt when there is an overload on the component, and having a disconnection device for disconnecting at least one of these joints. The invention also relates to a corresponding method for protecting an electrical component, in particular an electronic component arranged on a carrier device with current-carrying elements.

The overload on electronic components may result in them operating outside of a rated operating range. A power conversion on a damaged component caused by a reduced insulation strength of the component, for example, leads to an increased heating. If heating of the component beyond an allowed threshold is not prevented, this can lead to damage to the surrounding materials, the generation of off-gases or to a risk of fire.

It is therefore customary to provide a thermal fuse for such a component to allow it to be shut down when unacceptable heating occurs. However, this arrangement is not suitable for very rapid heating processes due to the limited thermal coupling possibility.

In overvoltage protection devices, it is customary to equip the overvoltage protection components that are used, in particular varistors with thermally activated disconnection devices.

A thermal overload protection arrangement for protecting an electronic power component arranged on a circuit board with printed conductors is known from the unexamined patent DE 10 2005 045 778 A1, in which the overload protection arrangement has a plurality of soldered joints which establish electrical contact with a respective terminal area of a ladder crossbar and melt when there is a thermal overload for each printed conductor of a circuit board and having a device with a temperature sensor and an opening element for disconnecting at least one of these joints.

Due to the spatial separation of component and overload protection arrangement, there is a certain inertia of the system on the one hand and on the other hand there is a need for a relatively great deal of space.

The object of the invention is to provide an overload protection arrangement and a method for protecting components which has a fast and reliable protective mechanism and is associated with the smallest possible space requirement on a mounting device.

This object is achieved according to the invention by the features of the independent claims. Advantageous embodiments of the invention are characterized in the dependent claims.

With the overload protection arrangement according to the invention, the part is the component itself or at least has the component, such that the separation device is a separation device which prestresses the component with respect to the mounting device—at least when there is heating—for spatial separation of the component from at least one of the current-carrying elements, which is tripped on melting of the soldered joint. The component, preferably an electronic component, is attached to current-carrying elements of the mounting device, for example, printed conductors of a circuit board, using a low-melting solder. The melting point of this solder is 150° C., for example. If there is any thermal stress on the component, the terminals conduct heat to the soldered joints. If the thermal stress goes beyond the melting point of the solder, the soldered joints melt. Since the separation device prestresses the component with respect to the carrier device, the melting of the soldered joints trips the separation device immediately, so that the separation device spatially separates the component permanently from the current-carrying elements due to its displacement. Due to the fact that a separate component is not used for opening an electrical circuit, this yields a reduction in the amount of space required. In addition, due to the tripping and separating elements connected directly to the component, there is a rapid separation.

According to a preferred embodiment of the invention, it is provided that the separation device has an actuator which is designed as (a) a spring mechanism and/or (b) a device made of an intumescent material and/or (c) a device made of a shape memory material and/or (d) a device made of a material which changes its shape chemically. Such an actuator prestresses the component with respect to the mounting device in general or at least in heating.

The alternatives (b) through (d) have the advantage that the soldered joints and/or the entire separation device are free of force in normal operation because a corresponding force occurs only after the release of the separation device with the actuator according to any one of the alternatives (b) through (d).

In one of these embodiments the separation device has a spring mechanism which is designed in particular as a compressive spring. Optionally the component or the spring mechanism may be secured by a low melting plastic to minimize the mechanical load on the soldered joints. The melting point of the soldered joint is above that of the melting plastic. If the low-temperature solder is embodied using flux agents so that it remains on the soldered surfaces reliably because of the surface tension in the event of a separation above the melting point, then the melting point of the fusible plastic used to secure the component or the spring element may be above the solder melting point.

It is provided in particular that the overload protection arrangement still has an arresting device which secures the separated component—alone or together with the separation device—in a defined position. This arresting device is provided to prevent uncontrolled movement of the component in a device having the mounting device after separation. An arresting device may advantageously be formed by a housing part which surrounds the mounting device. The fixation of the component in the arresting device is preferably a releasable fixation.

According to a refinement of the invention it is provided that the separation device is a separation device for shifting the component to separate it from the at least one current-carrying element across the surface of the mounting device. Such a separation device moves the component for separation across the surface of the mounting device, in particular in the direction of the surface normal to the surface of the mounting device.

In general the separation device and in particular its actuator are arranged next to the component, above the component, beneath the component or even beneath the mounting device. The separation device and in particular the actuator of the separation device are however, advantageously arranged between the mounting device and the component itself. Such an overload protection arrangement is designed to be particularly space saving. The actuator is especially preferably arranged between the mounting device and the center of gravity of the component. According to a preferred embodiment of the invention it is provided that the separation device is arranged between at least two of the soldered joints—in particular based on the surface area of the mounting device.

According to an alternative embodiment of the invention, which is also advantageous however, it is provided that the separation device is a separation device for displacing the component to separate same from the at least one of the current-carrying elements along the surface of the carrier device. Such a separation device moves the component for separation essentially along the surface of the mounting device, in particular moving it across an imaginary connecting line between two soldered joints coupled electrically to one another via the component.

According to a refinement of the invention, it is also provided that the overload protection arrangement also has the component and/or the mounting device. In general, the component may be any desired component. However, it is preferably embodied as a surface-mounted device (SMD).

Before a reflow solder process of the surface mounting, there is, for example, only partial assembly with a few of the component of the overload protection arrangement. Additional components are mounted only after the reflow soldering process. This variant of the embodiment is possible for all of the aforementioned types (a) through (d) of actuators.

In addition it is advantageously provided that the overload protection arrangement has the actuator which is embodied as a spring mechanism, the SMD component and the soldered joints and is designed as a surface mount arrangement. As an alternative to the partial assembly before the reflow process, in the case of a surface-mounted arrangement using an actuator designed as a spring mechanism, it is possible for the entire arrangement to be reflow-process-capable. Depending on the production process used with the arrangement, either (i) the prestress spring mechanism is blocked during the reflow process and then the spring mechanism is tripped by removing the blocking element or (ii) the spring device is free of force during the reflow process and the corresponding prestress is applied only after the reflow process.

With the inventive process, it is provided that several soldered joints, which electrically contact each current-carrying element to a corresponding terminal of the component and which melt when there is an overload on the component, are provided and a separation device for separating these joints is provided, such that the separation device prestresses the component with respect to the mounting device—at least when there is heating—and separates the component by melting of the soldered joints spatially from the current-carrying component.

The present invention is explained in greater detail below with reference to the accompanying drawings on the basis of preferred exemplary embodiments.

The drawings show:

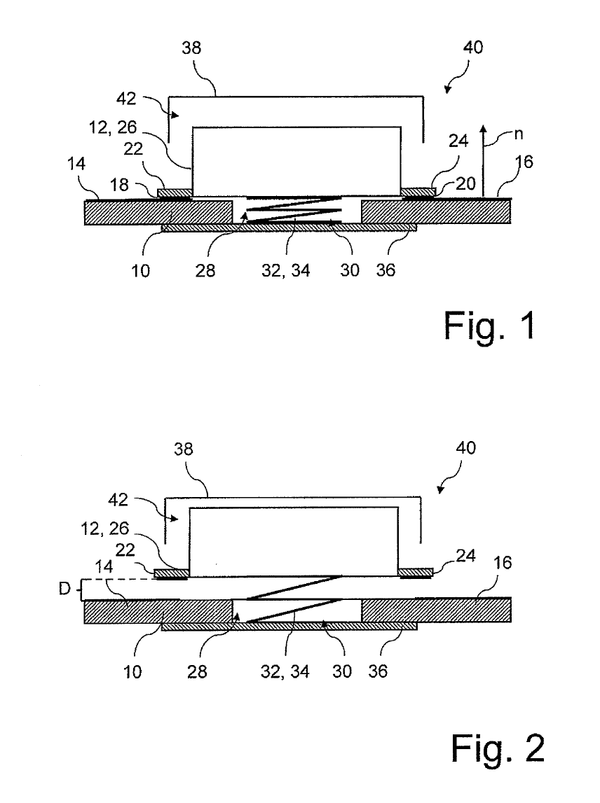

FIG. 1 shows an electronic component and a thermal overload protection arrangement in the untripped operating state according to a first embodiment of the invention,

FIG. 2 shows the component and the thermal overload protection arrangement from FIG. 1 in the tripped operating state,

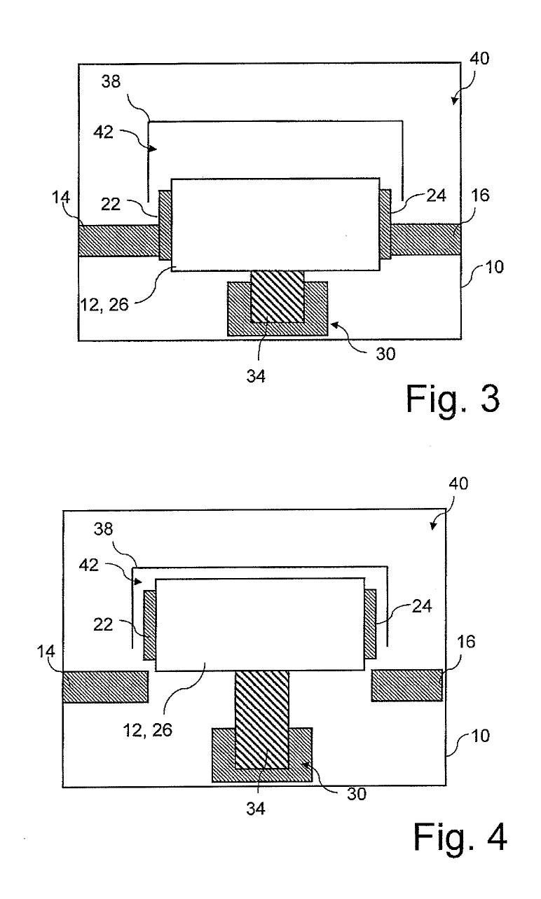

FIG. 3 shows an electronic component and a thermal overload protection arrangement in the tripped operating state according to a second embodiment of the invention, and

FIG. 4 shows the component and the thermal overload protection arrangement of FIG. 3 in the tripped operating state.

FIG. 1 shows a side view of a detail of a mounting device 10 designed as a circuit board for mounting and electrical contacting of electrical components 12, in particular electronic components. The mounting device 10 therefore has current-carrying elements 14, 16 designed as printed conductors on its top side, two of these current-carrying elements 14 and 16 being shown here. Each of these elements contacts a respective terminal 22, 24 of an electronic component 12 via a soldered joint 18, 20 using a low-melting solder. This electronic component is designed as an SMD component 26. One area of the mounting device 10 beneath this component 12 has a recess 28 designed as a through-passage. A separation device 30 with an actuator 34 designed as a spring mechanism 32 is arranged in the recess 28, prestressing the component 12 with respect to a base plate 36 of the carrier device 10 “under pressure” (compression spring).

The situation shown in FIG. 1 illustrates the component 12 on the carrier device 10 in its operating state. An arresting device 38, whose function will be discussed in conjunction with the description of FIG. 2, is arranged above, i.e., in the direction of the surface normal on the side of the mounting device 10 carrying the component.

The arrangement of the soldered joints 18, 20 and the separation device 30 in relation to the mounting device 10 and the component 12 is the thermal overload protection arrangement 40. The thermal overload protection arrangement 40 is a thermal overload protection arrangement 40 for protecting the electrical component 12 arranged on the mounting device 10. In the exemplary embodiments shown in FIGS. 1 through 4, this overload protection arrangement also has the arresting device 38.

This yields the following function of the overload safety arrangement 40: the separation device 30 prestresses the component 12 with respect to the mounting device 10, so that with increased thermal stress on the component 12, the soldered joints holding the component 12 on the mounting device 10 also heat up. If their temperature exceeds the melting point of the solder, then the soldered joints 18, 20 melt and the component 12 is separated from the mounting device and in particular from its current-carrying elements 14, 16 by means of the actuator 34 of the separation device 30 in the direction of the surface normal (arrow n). This situation is illustrated in FIG. 2.

To keep the component in a defined position after the separation process, the arresting device 38, which is designed like a basket, is arranged above the component 12. The actuator 34 of the separation device 30 shifts the component 12 into a receiving area of the arresting device 38 in the separation process and secures the component there by its residual tension. The position of the component 12 in the receiving area 42 of the arresting device 32 [sic; 38] ensures a sufficient distance D from the current-carrying elements 14, 16 of the mounting device 10 so that no spark gaps can occur.

The heating of the electronic component 12—due to the power loss in the component 12 itself—leads to a loss of strength of the soldered joints 18, 20. If the force of the spring mechanism 32 exceeds the holding forces of the soldered joints 18, 20, the component 12 is lifted up from the circuit board. After the separation from an electrical source causing the heating has been accomplished, the component 12 is thus converted to a secure state. The secure state is described by the fact that any additional heating is precluded and the electrical joints are irreversibly separated to ensure the electrical insulation.

If the device 30 has been implemented with a fixation of the spring mechanism 32 by means of a low-melting plastic, then this plastic melts first and thus trips the spring mechanism 32 shortly before the soldered joints melt.

With the help of an actuator 34 (not shown here) which acts on the basis of intumescent substances, a shape memory material or a thermally activated chemical reaction, a separation can also be achieved. If the actuator 34 heats up to its activation temperature because of the power loss of the component, this builds up a pressure on the component 12. Furthermore, the heating leads to a loss of strength of the soldered joints 18, 20. If the force of the actuator 30 exceeds the holding force of the soldered joints 18, 20, then the component 12 is lifted up from the circuit board. The separation from the electrical source is accomplished and thus the component 12 has been converted to a safe state by the overload protection arrangement 40.

The arrangement illustrated in FIGS. 3 and 4 corresponds essentially to the arrangement of FIGS. 1 and 2 so that only the differences need be discussed here.

FIGS. 3 and 4 show a detail of the mounting device 10 with surface-mounted component 12 (SMD component 26) in a view from above. FIG. 3 shows the arrangement in normal operation; FIG. 4 shows the arrangement with the separation device 30 of the overload protection arrangement 40 having been tripped.

The essential difference from the arrangement of FIGS. 1 and 2 is the arrangement of the separation device 30, component 12 and arresting device 38. These are now arranged in series on an imaginary axis along the surface of the mounting device one after the other. If the soldered joints 18, 20 melt, then the separation device 30 shifts the component 12 to separate it from the current-carrying elements 14, 16, shifting it essentially along the surface of the mounting device 10, in particular across an imaginary connecting line between the two soldered joints 18, 20, which are electrically linked together via the component 12.

List of Reference Numerals

| | |
|---|---|
| Mounting device | 10 |
| Component | 12 |
| Current-carrying element | 14 |
| Current-carrying element | 16 |
| Soldered joint | 18 |
| Soldered joint | 20 |
| Terminal | 22 |
| Terminal | 24 |
| SMD component | 26 |
| Recess | 28 |
| Separation device | 30 |
| Spring mechanism | 32 |
| Actuator | 34 |
| Base plate | 36 |
| Arresting device | 38 |
| Overload protection arrangement | 40 |
| Receiving area | 42 |

1. A thermal overload protection arrangement (40) for protecting an electrical component (12) arranged on a mounting device (10) having current-carrying elements (14, 16), in particular an electronic component, such that the overload protection arrangement (40) has a plurality of soldered joints (18, 20) which contact one of the current-carrying elements (14, 16) with a respective terminal (22, 24) of an electrical part and which melt when there is an overload on the component (12), and having a separation device (30) for releasing at least one of these joints (18, 20) and for shifting the component (12) to separate the component (12) from the at least current-carrying element (14,16) along the surface of the mounting device (10), characterized in that the part is or at least has the component (12), and the separation device (30) is a separation device which prestresses the component (12) with respect to the mounting device (10) at least when there is heating for a spatial separation of the component (12) from at least one of the current-carrying elements (14, 16) which is tripped when the soldered joints (18, 20) are melted.

2. The overload protection arrangement according to claim 1, wherein the separation device (30) has an actuator (34) which is designed as a spring mechanism (32) and/or as a device made of intumescent material and/or a device made of a shape memory material and/or a device made of a material which chemically changes its shape.

3. The overload protection arrangement according to claim 1, having an arresting device (38) which secures the separated component (12)—alone or together with the separation device (30)—in a defined position.

4. The overload protection arrangement according to claim 1, wherein the separation device (30) is a separation device for shifting the component (12) to separate it from the at least one current-carrying element (14, 16) across the surface of the mounting device (10) in particular in the direction of the surface normal of the surface of the carrier device (10).

5. The overload protection arrangement according to claim 4, wherein the separation device (30) is arranged between the mounting device (10) and the component (12).

6. The overload protection arrangement according to claim 2, wherein the actuator (34) is arranged between at least two of the soldered joints (18, 20).

7. The overload protection arrangement according to claim 1, wherein the separation device (30) is a separation device for shifting the component (12) to separate it from the at least one current-carrying element (14, 16) along the surface of the mounting device (10).

8. The overload protection arrangement according to claim 1, wherein the overload protection arrangement (40) has the component (12) and/or the mounting device (10).

9. The overload protection arrangement according to claim 8, wherein the component (12) is designed as an SMD component (26).

10. The overload protection arrangement according to claim 9, wherein the arrangement (40) has the actuator (34) which is designed as a spring mechanism (32), the SMD component (26) and the soldered joints (18, 20) and is designed as a surface mount arrangement.

11. A method for protecting an electrical component arranged on a mounting device having current-carrying elements, in particular an electronic component, wherein a plurality of soldered joints which contact one of the current-carrying elements to a corresponding terminal of the component electrically and melt when there is an overload on the component and having a separation device for tripping these joints, such that the separation device prestresses the component with respect to the mounting device—at least when heated—and separate the component spatially from the current-carrying elements when the soldered joints are melted.
